(19) United States
(12) Patent Application Publication
(10) Pub. No.: US 2023/0265712 A1
(43) Pub. Date: Aug. 24, 2023

(54) WINDOW CURTAIN

(71) Applicant: SHEEN WORLD TECHNOLOGY CORPORATION, TAICHUNG CITY (TW)

(72) Inventor: PO-YU CHEN, TAICHUNG CITY (TW)

(21) Appl. No.: 17/675,497

(22) Filed: Feb. 18, 2022

(51) Int. Cl. E06B 9/303

(52) U.S. Cl. CPC E06B 9/303

(57) ABSTRACT

A window curtain includes a headrail and a covering structure. The headrail has a bottom wall, two stand walls connected with two opposites sides of the bottom wall, and a light-blocking portion protruding downwards from a junction of the bottom wall and one of the stand walls. The covering structure is positioned under the headrail and has a ladder tape and a plurality of slats. The ladder tape has two vertical cords and a plurality of traverse cords connected between the vertical cords and arranged in an equally-spaced manner along the vertical cords. The slats are held by the traverse cords in a one-to-one manner so as to be tilted by the ladder tape for providing a light-blocking effect. When the slats are tilted, a part of a topmost slat is covered by the light-blocking portion of the headrail to solve the problem of light leakage.

### BACKGROUND OF THE INVENTION

### 1. Field of the Invention

The present invention relates to a window curtain and more particularly, to a window curtain that can solve the problem of light leakage.

### 2. Description of the Related Art

As far as a conventional window curtain is concerned, when all slats are lowered, they are adapted to be driven by the ladder tape to tile relative to the headrail for providing a light-blocking effect. However, after the slats are titled, the gap between the bottom surface of the headrail and the topmost slat will cause the problem of light leakage, causing people to feel dazzling and uncomfortable.

In order to solve the aforesaid problem, the window covering disclosed by US 2020/0018115 A1 provides a light-blocking bar protruding from the bottom surface of the headrail rail. When all slats are driven by the ladder tape to tilt relative to the headrail, a part of the topmost slat is covered by the light-blocking bar to eliminate the gap between the topmost slat and the bottom surface of the headrail. Therefore, the problem of light leakage is solved.

### SUMMARY OF THE INVENTION

It is a primary objective of the present invention to provide a window curtain, which eliminates a gap to solve the problem of light leakage.

To attain the above objective, the window curtain of the present invention comprises a headrail and a covering structure. The headrail includes a bottom wall, two stand walls connected with the front and rear sides of the bottom wall, and a light-blocking portion protruding downwards from a junction of the bottom wall and one of the stand walls. The covering structure is positioned under the headrail and includes a ladder tape and a plurality of slats. The ladder tape has two vertical cords and a plurality of traverse cords connected between the vertical cords and arranged in an equally-spaced manner along the extending directions of the vertical cords. The slats are held by the traverse cords in a one-to-one manner such that the slats can be adjusted by the ladder tape to a tilted state. When the slats are in the tilted state, a part of a topmost slat of the slats is covered by the light-blocking portion of the headrail.

It can be understood from the above illustration that the window curtain of the present invention uses the light-blocking portion to eliminate a gap between the bottom surface of the headrail and the topmost slat to solve the problem of light leakage.

Preferably, a straight section extends downwards from the bottom side of one of the stand walls, and a concave arc section extends outwards from one of the long sides of the bottom wall. The straight section and the concave arc section are connected together through a convex arc section. By this way, the light-blocking portion is formed by the straight section, the concave arc section, and the concave arc section.

Preferably, the light-blocking portion extends continuously from one end of the headrail to the other end of the headrail along the longitudinal direction of the headrail.

Preferably, two light-blocking portions extend downwards from the junctions of the stand walls and the bottom wall, i.e., the headrail has two opposite light-blocking portions.

Preferably, a recess is formed between the light-blocking portions. The covering structure further includes a lifting cord connected with the slats to drive the slats to a lifted state. When the slats are in the lifted state, the topmost slat is received in the recess.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a partially perspective view of a window curtain of the present invention, showing the slats are in the tilted state.

FIG. 2 is a perspective view of a headrail provide by the window curtain of the present invention.

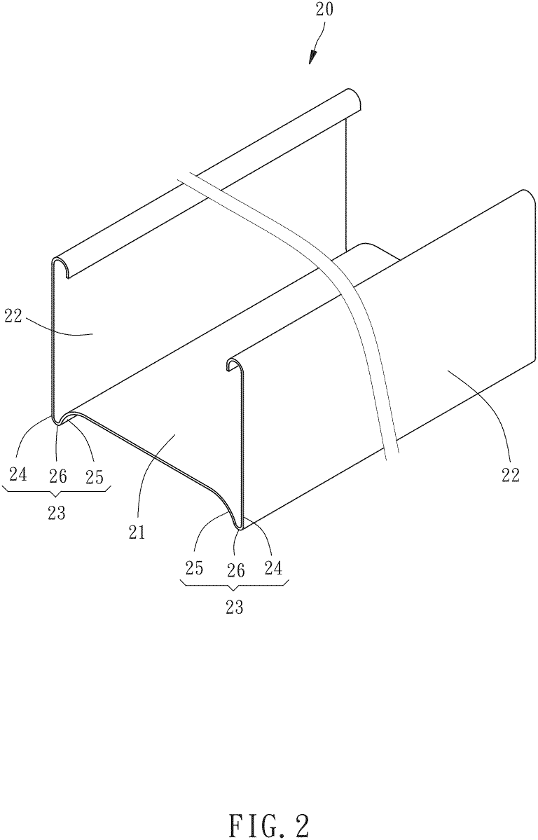

FIG. 3 is a partially lateral view of the window curtain of the present invention, showing the slats are in the tilted state.

FIG. 4 is a partially lateral view of the window curtain of the present invention, showing the slats are in the lifted state.

### DETAILED DESCRIPTION OF THE INVENTION

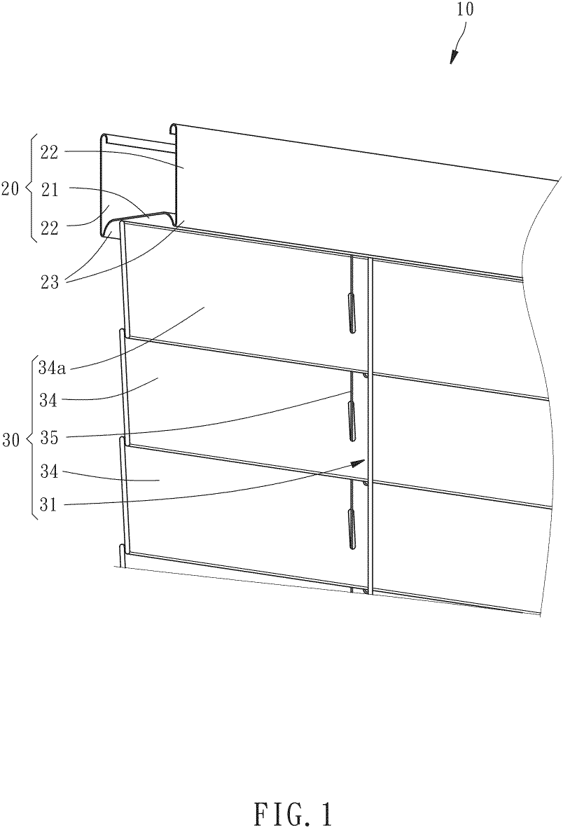

Referring to FIG. 1, a window curtain 10 of the present invention comprises a headrail 20 and a covering structure 30.

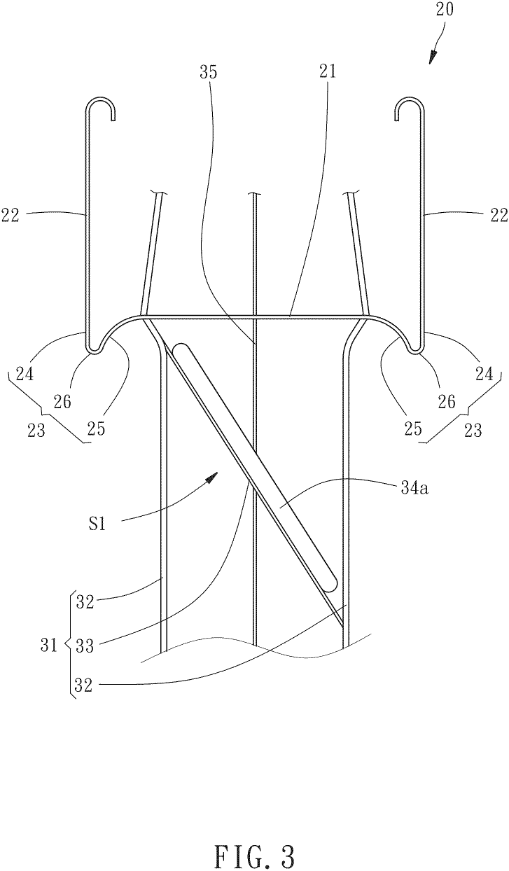

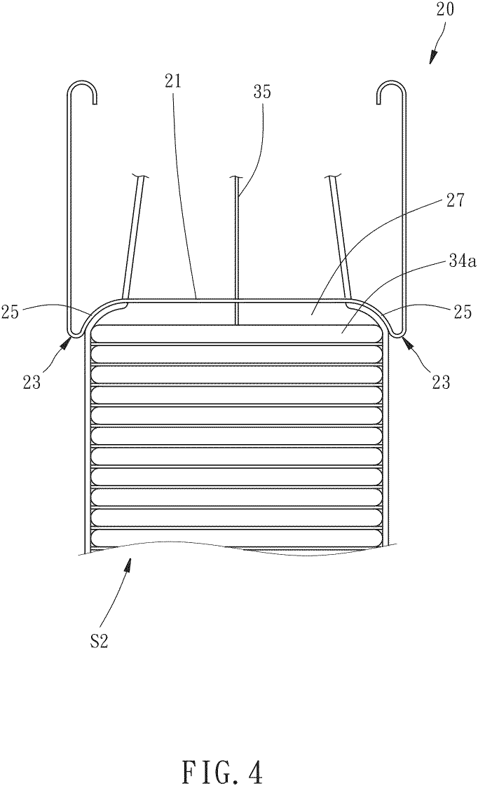

As shown in 2, the headrail 20 includes a bottom wall 21 and two stand walls 22 connected integrally with the front and rear sides of the bottom wall 21. In addition, the headrail 20 includes two light-blocking portions 23 (actually, at least one is sufficient) protruding integrally downwards from the junctions of the stand walls 22 and the bottom wall 21 and extending continuously from one end of the headrail 20 to the other end of the headrail 20 along the longitudinal direction of the headrail 20. Further, as shown in FIG. 3, the light-blocking portions 23 each have a straight section 24, a concave arc section 25, and a convex arc section 26. One ends of the straight sections 24 are connected integrally with the bottom sides of the stand walls 22, and one ends of the concave arc sections 25 are connected integrally with the front and rear sides of the bottom wall 21, and the convex arc sections 26 are connected integrally between the straight sections 24 and the concave arc section 25. By this way, as shown in FIG. 4, a recess 27 is formed between the light-blocking portions 23 and adjacent under the bottom wall 21.

The covering structure 30 is positioned under the headrail 20. As shown in FIGS. 1 and 3, the covering structure 30 includes at least one ladder tape 31 (the number is adjustable according to the size of the window curtain 10). The ladder tape 31 has two vertical cords 32 and a plurality of traverse cords 33 (the number is unlimited as long as the traverse cord 33 is equal in number to the number of the slat 34). The top ends of the vertical cords 32 are penetrated into the headrail 20 and connected with a light-adjusting device (the light-adjusting device is known in the prior art and not shown in the drawings) disposed in the headrail 20. The traverse cords 33 are connected between the vertical cords 32 and arranged in an equally-spaced manner along the extending directions of the vertical cords 32. The covering structure 30 further includes a plurality of slats 34 (the number is unlimited as long as the slat 34 is equal in number to the number of the traverse cords 33) held by the traverse cords 33 in a one-to-one manner. Thus, the ladder tape 31 can be driven by the aforesaid light-adjusting device to adjust the tilted angle of the slats 34, such that the slats 34 can be adjusted to a tilted state S1 (as shown in FIG. 3) for providing a light-blocking effect. When the slats 34 are in the tilted state S1 as shown in FIG. 3, a part of a topmost slat 34a is covered by the light-blocking portions 23 of the headrail 20 to eliminate a gap between the headrail 20 and the topmost slat 34a. thereby solving the problem of light leakage.

On the other hand, the covering structure 30 further includes at least one lifting cord 35 (the number is adjustable according to the size of the window curtain 10) connected with the slats 34. One end of the lifting cord 35 is penetrated into the headrail 20 and connected with a cord winder (the cord winder is known in the prior art and not shown in the drawings), such that the lifting cord 35 can be driven by the cord winder to adjust the slats 34 to a lifted state S2 as shown in FIG. 4. When the slats 34 are in the lifted state S2 as shown in FIG. 4, the topmost slat 34a is received in the recess 27, and the front and rear sides of the topmost slat 34a are abutted against the concave arc sections 25 of the light-blocking portions 23 for preventing the topmost slat 34a from being damaged or broken by the bottom wall 21 of the headrail 20.

What is claimed is:

1. A window curtain comprising:
a headrail including a bottom wall, two stand walls connected with front and rear sides of the bottom wall, and a light-blocking portion protruding downwards from a junction of the bottom wall and one of the stand walls; and
a covering structure positioned under the headrail and including a ladder tape having two vertical cords and a plurality of traverse cords connected between the vertical cords and arranged in an equally-spaced manner along extending directions of the vertical cords, and a plurality of slats held by the traverse cords in a one-to-one manner such that the slats can be adjusted by the ladder tape to a tilted state, wherein when the slats are in the tilted state, a part of a topmost slat of the slats is covered by the light-blocking portion of the headrail.

2. The window curtain as claimed in claim 1, wherein the light-blocking portion has a straight section provided with one end connected with one of the stand walls, a concave arc section provided with one end connected with the bottom wall, and a convex arc section connected between the straight section and the concave arc section.

3. The window curtain as claimed in claim 1, wherein the light-blocking portion extends continuously from one end of the headrail to the other end of the headrail along a longitudinal direction of the headrail.

4. The window curtain as claimed in claim 1, wherein the headrail includes two said light-blocking portions protruding downwards from the junctions of the bottom wall and the stand walls.

5. The window curtain as claimed in claim 4, wherein a recess is formed between the light-blocking portions; the covering structure further includes a lifting cord connected with the slats to drive the slats to a lifted state, wherein when the slats are in the lifted state, the topmost slat is received in the recess.
